(19) United States
(12) Patent Application Publication
(10) Pub. No.: US 2012/0250357 A1
(43) Pub. Date: Oct. 4, 2012

(54) POWER SUPPLYING DEVICE AND IMAGE FORMING APPARATUS HAVING THE SAME

(75) Inventors: Takahiro YOKOYA, Toyokawa-shi (JP); Mikiyuki Aoki, Toyohashi-shi (JP); Junichi Masuda, Toyokawa-shi (JP); Taku Kimura, Hoi-gun (JP)

(73) Assignee: Konica Minolta Business Technologies, Inc., Chiyoda-ku (JP)

(21) Appl. No.: 13/434,414

(22) Filed: Mar. 29, 2012

(30) Foreign Application Priority Data
Apr. 1, 2011 (JP) 2011-082315

(51) Int. Cl. H02M 3/335

(52) U.S. Cl. 363/16

(57) ABSTRACT

A power supplying device provides power to the body of an image forming apparatus and an optional device connected to the body of the same. The power supplying device comprises: a rectifier circuit which rectifies an alternating current inputted from an alternating-current source; a booster circuit which boosts and smooths the direct-current voltage caused by the rectifier circuit; a judgment portion which judges whether or not there is an optional device connected to the body of the image forming apparatus; an identification portion which identifies the type of the optional device connected thereto; and a controller which, if there is an optional device connected thereto according to the judgment portion, adjusts the boosted voltage obtained by the booster circuit to a higher value than that if there is no optional device connected thereto, which depends on the type of the optional device identified by the identification portion.

This application claims priority under 35 U.S.C. §119 to Japanese Patent Application No. 2011-082315 filed on Apr. 1, 2011, the entire disclosure of which is incorporated herein by reference in its entirety.

### BACKGROUND OF THE INVENTION

1. Field of the Invention

The present invention relates to: a power supplying device to be installed on an image forming apparatus; and an image forming apparatus with this power supplying device being installed thereon.

2. Description of the Related Art

The following description sets forth the inventor's knowledge of related art and problems therein and should not be construed as an admission of knowledge in the prior art.

Some of the multifunctional digital image forming apparatuses collectively having various functions such as the copier function, the printer function, and the facsimile function, which are called MFPs, allow an optional device, an automatic document feeder (ADF) for example, to connect to their own bodies.

It is necessary for such image forming apparatuses to obtain input current as much as needed from power supplied from one outlet, even when such an optional device is connected to their bodies.

To obtain input current as much as needed, such image forming apparatuses conventionally have made a power supplying device which employs a boost chopper circuit for example, as a power factor correction circuit, reduce the input current.

However, it has been disadvantageous that such a power supplying device may lose power supplying device efficiency because of the power loss caused by a switching element provided in a boost chopper. To improve power supplying device efficiency and achieve power saving, such image forming apparatuses conventionally have turned OFF a power factor correction circuit when power factor correction is not needed.

For example, as disclosed in Japanese Unexamined Patent Publication No. 2005-168146, there is a technology to detect an output power of a rectifier circuit of a power supplying device, then turn ON the power factor correction function if the detected output power is equal to or higher than a predetermined value; and turn OFF the power factor correction function if the detected output power is lower than a predetermined value.

However, the technology disclosed in the Japanese Unexamined Patent Publication No. 2005-168146 has the following disadvantage.

The body of an image forming apparatus may be connected to by various types of optional devices, and load currents applied to such optional devices are different from each other.

However, in the technology disclosed in the Japanese Unexamined Patent Publication No. 2005-168146, the power factor correction function is either in the ON or OFF state regardless of the type of an optional device connected to the body of an image forming apparatus, and thus it has been disadvantageous that the best power supplying device efficiency and a power factor that most closely matches the type of an optional device connected to the body of an image forming apparatus, hardly can be achieved.

The description herein of advantages and disadvantages of various features, embodiments, methods, and apparatus disclosed in other publications is in no way intended to limit the present invention. Indeed, certain features of the invention may be capable of overcoming certain disadvantages, while still retaining some or all of the features, embodiments, methods, and apparatus disclosed therein.

### SUMMARY OF THE INVENTION

A first aspect of the present invention relates to a power supplying device providing power to the body of an image forming apparatus and an optional device connected to the body of the same, the power supplying device comprising:
a rectifier circuit which rectifies an alternating current inputted from an alternating-current source;
a booster circuit which boosts and smooths the direct-current voltage caused by the rectifier circuit;
a judgment portion which judges whether or not there is an optional device connected to the body of the image forming apparatus;
an identification portion which identifies the type of the optional device connected thereto; and
a controller which, if there is an optional device connected thereto according to the judgment portion, adjusts the boosted voltage obtained by the booster circuit to a higher value than that if there is no optional device connected thereto, which depends on the type of the optional device identified by the identification portion.

A second aspect of the present invention relates to a power supplying device achieving the control of another power supplying device providing power to the body of an image forming apparatus and an optional device connected to the body of the same, the power supplying device comprising:
a rectifier circuit which rectifies an alternating current inputted from an alternating-current source;
a booster circuit which boosts and smooths the direct-current voltage caused by the rectifier circuit;
a judgment portion which judges whether or not there are a plurality of optional devices connected to the body of the image forming apparatus;
an identification portion which identifies the combination of the optional devices connected thereto; and
a controller which, if there are a plurality of optional devices connected thereto according to the judgment portion, adjusts the boosted voltage obtained by the booster circuit to a higher value than that if there are no optional devices connected thereto, which depends on the combination of the optional devices identified by the identification portion.

The above and/or other aspects, features and/or advantages of various embodiments will be further appreciated in view of the following description in conjunction with the accompanying figures. Various embodiments can include and/or exclude different aspects, features and/or advantages where applicable. In addition, various embodiments can combine one or more aspect or feature of other embodiments where applicable. The descriptions of aspects, features and/or advantages of particular embodiments should not be construed as limiting other embodiments or the claims.

### BRIEF DESCRIPTION OF THE DRAWINGS

The preferred embodiments of the present invention are shown by way of example, and not limitation, in the accompanying figures, in which:

FIG. 1 is a front view of an image forming apparatus according to one mode of implementing the present invention;

FIG. 2 is a circuit diagram illustrating a power supplying device installed on the body of the image forming apparatus;

FIG. 3 is another circuit diagram illustrating a power supplying device installed on the body of the image forming apparatus;

FIG. 4 is a table including a predetermined value of boosted voltage depending on the type of an optional device connected or the combination of optional devices connected; and

FIG. 5 is a flowchart representing the operation to select a predetermined value of boosted voltage depending on whether or not there are any optional devices connected.

### DETAILED DESCRIPTION OF THE PREFERRED EMBODIMENTS

In the following paragraphs, some preferred embodiments of the invention will be described by way of example and not limitation. It should be understood based on this disclosure that various other modifications can be made by those in the art based on these illustrated embodiments.

Hereinafter, a mode of implementing the present invention will be described with reference to the accompanying drawings.

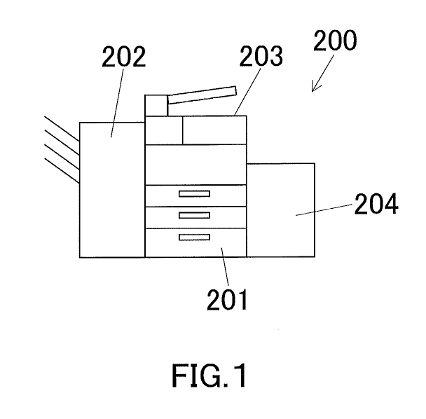

FIG. 1 is a front view illustrating an image forming apparatus 200 according to one embodiment of the present invention. The image forming apparatus 200 is provided with the body 201 of the image forming apparatus which is capable of being connected to by a plurality of optional devices after being shipped from factory, according to the needs of users and the like. Surely the body 201 may be connected to by a plurality of optional devices when it is shipped from factory.

A finisher 202 capable of performing various finishing operations such as hole-punching, stapling, and folding, on printed paper; an automatic document feeder (ADF) 203; and a large-capacity tray (also referred to as LCT) 204, for example, may be employed as the optional devices to be connected to the body 201. However, such optional devices should not be limited to these.

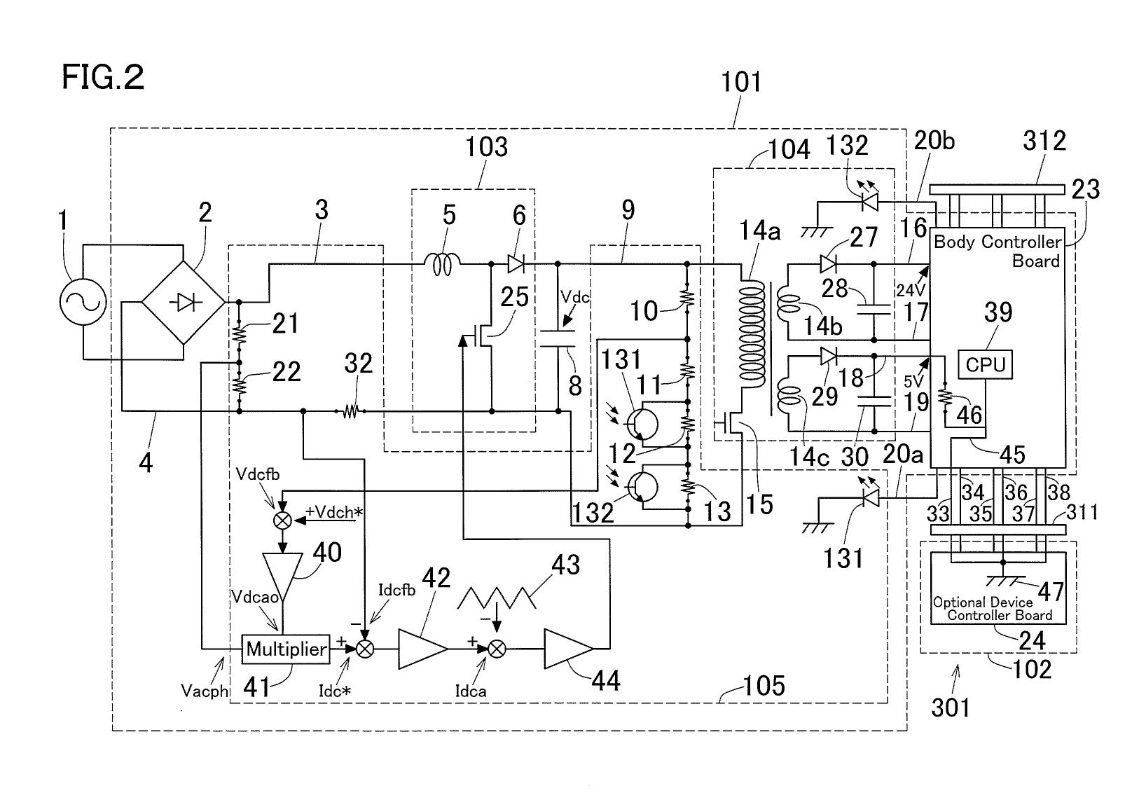

FIG. 2 is a circuit diagram illustrating a power supplying device of the image forming apparatus 200. In this mode of implementation, the body 201 of the image forming apparatus is connected to by only one optional device.

As illustrated in FIG. 1, the code 101 represents a body circuit provided in the body 201 of the image forming apparatus; and the code 102 represents an optional device circuit provided in an optional device 301. A body controller board 23 of the body circuit 101 and an optional device controller board 24 of the optional device circuit 102 are connected to each other via a connector 311 allowing the optional device 301 to connect to the body 201. The connector 31 includes: a line 33 which delivers control signals to control the optional device 301; a line 34 which delivers detection signals notifying of connection success of the optional device 301; a line 35 and a GND 36 which deliver 24V voltage from the body controller board 23 to the optional device controller board 24; a line 37 which delivers 5V voltage from the body controller board 23 to the optional device controller board 34; and a GND 38.

Although FIG. 2 illustrates an example in which the body 201 of the image forming apparatus is connected to by only one optional device 301, the body 201 is, actually, further provided with a connector 312 in addition to the connector 311, in order to be connected to by another optional device. These connectors match different optional devices. There are two connectors illustrated in the example of FIG. 2, but that may be three or more: the body 201 may be capable of being connected to by three or more optional devices.

The body circuit 101 includes: a full-wave rectifier circuit 2 consisting of bridge diodes connected to an alternating-current source 1 which is an external commercial power supplying device; a boost chopper circuit 103 which is a power factor corrector having the power factor correction function; a boost chopper controller circuit 105; a smoothing capacitor 8; a voltage converter circuit 104; and the above-mentioned body controller board 23. The boost chopper circuit 103 and the smoothing capacitor 8 jointly form a boost circuit. The optional device circuit 102 includes the optional device controller board 24.

The full-wave rectifier circuit 2 performs full-wave rectification on alternating current voltage from the alternating-current source 1. The boost chopper circuit 103 boosts the direct-current voltage caused by rectification and inputted via the line 3 to make the input power factor approximately to 1. Specifically, the boost chopper circuit 103 turns ON a MOSFET 25 connected to the line 3 via a choke coil 5, which serves as a switching element, for a certain period of time to store energy on the choke coil 5. After that, the boost chopper circuit 103 turns OFF the MOSFET 25 for another certain period of time to transfer the energy stored on the choke coil 5 to the smoothing capacitor 8 via a diode 6 and a positive-electrode line 9. By the repetition of these operations, smooth direct-current voltage can be stored on the smoothing capacitor 8 as boosted voltage Vdc.

Hereinafter, the ON/OFF control operations of the MSFET 25 will be described.

The alternating current phase difference signals Vacph, which are obtained by the resistances 21 and 22 exerting a voltage divider effect on the direct-current voltage caused by the full-wave rectifier circuit 2, are inputted to a multiplier 41. Subsequently, proportional-integral control is performed by an amplifier 40: the feedback voltage signals Vdcfb, which are caused by the resistances 10, 11, 12, and 13 exerting a voltage divider effect on the boosted voltage Vdc stored on the smoothing capacitor 8, are adjusted to a value proportional to the integral of a predetermined boosted voltage Vdch*.

Subsequently, the output Vdcao of the amplifier 40 is inputted to the multiplier 41 then multiplied by the alternating current phase difference signals Vacph. And proportional-integral control is further performed by an amplifier 42: the current signals Idc* obtained by multiplication is adjusted to a rate proportional to the integral of a direct current Ldcfb which is detected by a direct current detection resistance 32 connected to the MOSFET 25 via the line 4. And then, PWM duty signals for the MOSFET 25 can be obtained by a comparator 44 which compares the output Idcs of the amplifier 42 to a triangular wave generated by a triangular wave generator 43 serving as a PWM inverter.

The charging voltage Vdc of the smoothing capacitor 8 is adjust to a constant value by the control of the voltage converter circuit 104 whose configuration will be described below.

In the voltage converter circuit 104, by controlling the ON/OFF state, a MOSFET 15 which is connected to the smoothing capacitor 8 via a first coil 14a for a first voltage converter, is allowed to insulate the first coil 14a from second coils 14b and 14c for a second voltage converter in order to decrease the voltage of the second coils 14b and 14c less than that of the first coil 14a. In other words, the output voltage is adjusted to a constant value by controlling the duty ratio of the ON and OFF cycles of the MOSFET 15. Subsequently, rectification is performed by a diode 27 on the voltage transferred to the second coil 14b and the direct-current voltage caused is smoothed by a smoothing capacitor 28, and then the smooth 24V voltage obtained is provided to the body controller board 23 via a 24V terminal 16 and a GND 17.

Meanwhile, rectification is performed by a diode 29 on the voltage transferred to the second coil 14c and the direct-current voltage caused is smoothed by a smoothing capacitor 30, and then the smooth 5V voltage obtained is provided to the body controller board 23 via a 5V terminal 18 and a GND 19.

The body controller board 23 is provided with a CPU 39. The CPU 39 detects a connection of an optional device and adjusts the charging voltage (boosted voltage) Vdc of the smoothing capacitor 8, which is the output of the boost chopper 103, to a predetermined value, according to an operation program stored on a ROM or the like not illustrated in any of the accompanying figures.

The following will explain how the CPU 39 detects a connection of the optional device 301. In this mode of implementation, a line 45 is provided to the body controller board 23 as a connection detector; the line 45, which is connected to by a resistance 46 and the 5V terminal 18, extends to the line 33 delivering control signals to control the optional device 301. When the optional device 301 is not connected, the 5V voltage input line delivers H-level signals to the CPU 39 via the resistance 46. And according to the signals, the CPU 39 detects no connection of the optional device 301. In this mode of implementation, the line 45 extends to the line 33 to connect to a GND 47 of the optional device controller board 24 of the optional device 301; and when the optional device 301 is connected, the 5V voltage input line delivers L-level signals to the CPU 39. And according to the signals, the CPU 39 detects a connection of an optional device 102.

Detecting no connection of the optional device 301 because of receiving H-level signals, the CPU 39 turns OFF a photocoupler 131 via a line 20a. The photocoupler 131, when it is ON, serves to cause a short-circuit in the resistance 12 which is one of the resistances coupled in series with each other but coupled in parallel with the smoothing capacitor 8. Here, the photocoupler 131 is now OFF, and the resistances 10, 11, 12 and 13 exert a voltage divider effect on the boosted voltage Vdc stored on the smoothing capacitor 8, to cause feedback voltage signals Vdcfb. That results in giving a priority to power supplying device efficiency over power factor; while the boosted voltage Vdc on the both ends of the smoothing capacitor 8 is adjusted around to a constant value, 300V for example, the power factor and the power supplying device efficiency are kept to 90% and 85%, for example, respectively.

Detecting a connection of the optional device 301 because of receiving L-level signals, the CPU 39 turns ON the photocoupler 131 via the line 20a to cause a short-circuit in the resistance 12. When a short-circuit is caused in the resistance 12, the resistances 10, 11, and 13 exert a voltage divider effect on the boosted voltage Vdc stored on the smoothing capacitor 8, to cause feedback voltage signals Vdcfb whose value is lower than that the resistances 10, 11, 12, and 13 could cause. That results in giving a priority to power factor over power supplying device efficiency: while the voltage Vdc on the both ends of the smoothing capacitor 8 is adjusted to a higher value than that if no connection of the optional device 301 is detected, the power factor and the power supplying device efficiency are kept to 99% and 80%, for example, respectively.

Detecting that another optional device than the optional device 301 is connected to the connector 312, the CPU 39 of the body controller board 23 raises the voltage Vdc on the both ends of the smoothing capacitor 8 by turning ON another photocoupler 132 to cause a short-circuit in the resistance 13.

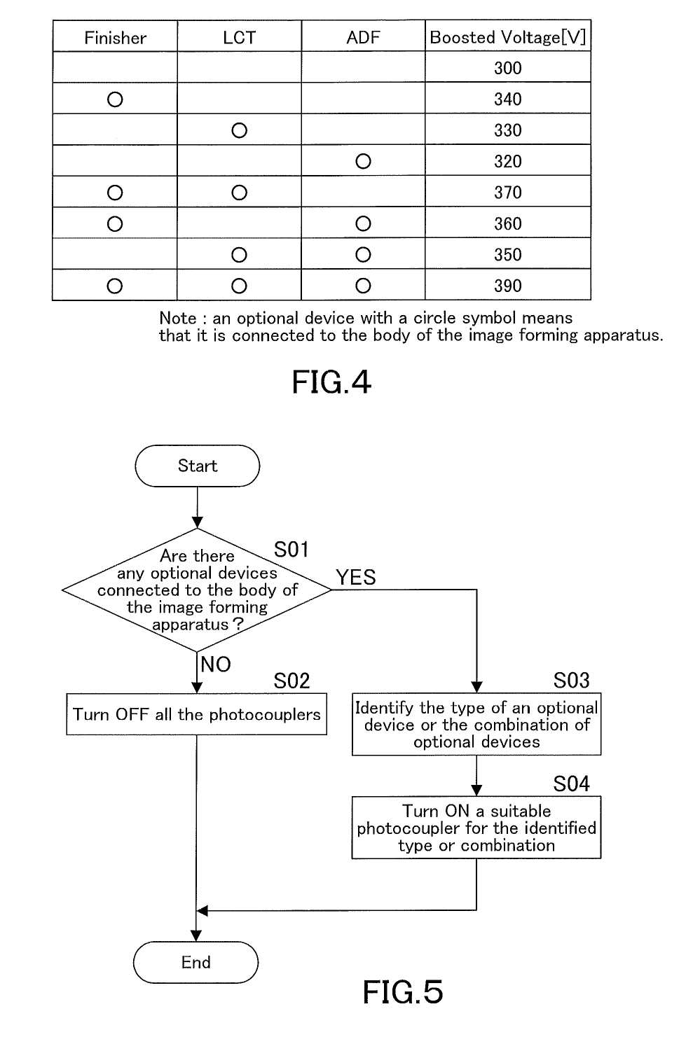

When there is an optional device connected, the voltage Vdc on the both ends of the smoothing capacitor 8 is adjusted to a predetermined value depending on the type of the optional device connected, for example according to the table of FIG. 4.

According to the setting of FIG. 4, when there is no optional device connected, the voltage Vdc is adjusted to 300V; when a finisher is connected as an optional device, the voltage Vdc is adjusted to 340V; when an LCT is connected, the voltage Vdc is adjusted to 330V; and when an ADF is connected, the voltage Vdc is adjusted to 320V. The higher the load current applied to the optional device is, the higher value the voltage Vdc will be adjusted to according to the setting. Depending on the type of the optional device connected, the photocoupler 131 or 132 is turned ON and a short-circuit is caused in the resistance 12 or 13. And the resistances excluding the resistance 12 or 13 produce a voltage divider effect at their own and predetermined ratios of partial pressure so that the voltage Vdc will be adjusted to a predetermined value.

As described above, the higher the load current applied to the optional device is, the higher value the boosted voltage Vdc will be adjusted to according to the setting. And therefore, when a hard disk drive (HDD) requiring a low load current is connected as an optional device, it is only necessary to keep the same voltage Vdc as when there is no optional device connected.

And also as described above, the connectors 311 and 312 are exclusively provided for the optional device 301 and 302, respectively, and the CPU 39 is therefore allowed to identify the type of an optional device connected.

In other words, the voltage (boosted voltage) Vdc on the both ends of the smoothing capacitor 8 is adjusted to an appropriate value depending on whether or not there is an optional device connected and also depending on the type of the optional device connected. And the image forming apparatus is allowed to work with power supplied from one outlet while saving on energy consumption.

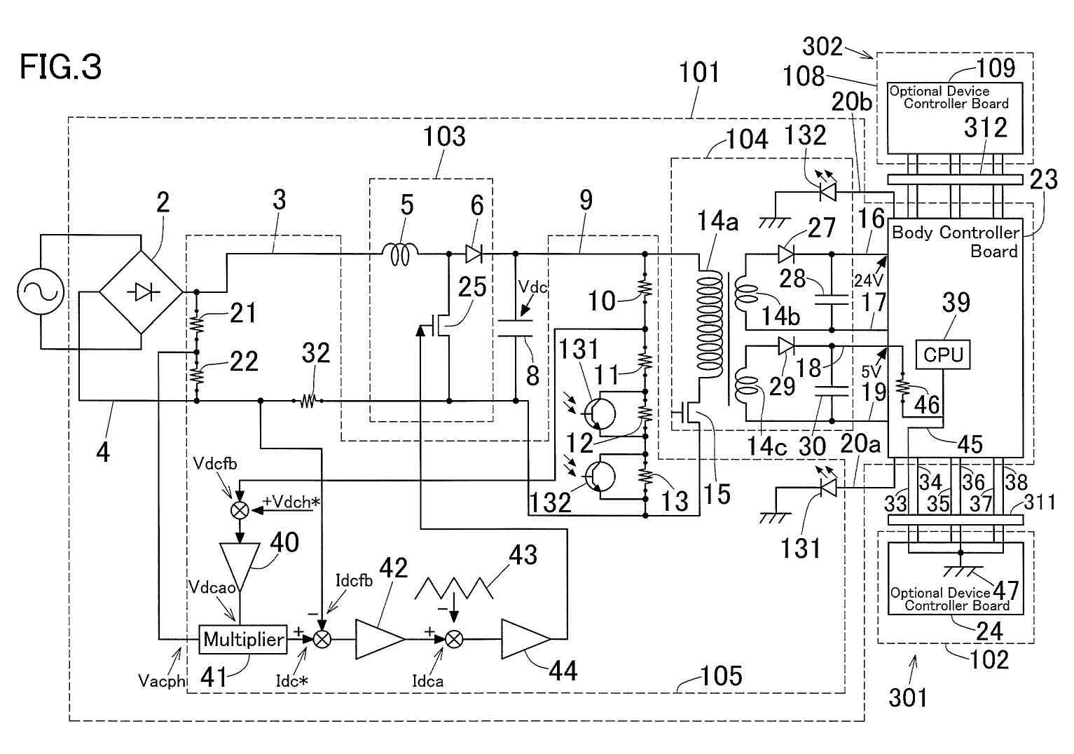

FIG. 3 is a circuit diagram illustrating a power supplying device of an image forming apparatus according to another mode of implementing the present invention. In this mode of implementation, there are two optional devices connected to the body 201 of the image forming apparatus: the optional devices 301 and 302. There may be three or more optional devices connected thereto.

In this mode of implementation, the optional device controller board 24 of the optional device 301 is connected to the body controller board 23 via the connector 311; the optional device controller board 109 of the optional device 302 is connected to the body controller board 23 via the connector 312.

Connections of the optional device 301 and 302 are detected and the types of them are identified exactly in the same way as in the case of FIG. 2. Here, explanation of the configuration of the body circuit 101 will be omitted because it is exactly the same as that of the other mode of implementation illustrated in FIG. 2.

In this mode of implementation, the line 33 is allowed to connect to the line 45 as long as the optional device 301 is connected. And L-level signals are delivered to the CPU 39 because the GND 47 of the optional device controller board 24 is connected to the line 33, and according to the signals, the CPU 39 detects a connection of the optional device 301. In the same way, the CPU 39 also detects a connection of the optional device 302.

Detecting connections of the optional devices 301 and 302, the CPU 39 turns ON the photocouplers 131 and 132 via the lines 20a and 20b to cause a short-circuit in the resistances 12 and 13, respectively. When a short-circuit is caused in the resistances 12 and 13, the resistances 10 and 11 exert a voltage divider effect on the boosted voltage Vdc on the both ends of the smoothing capacitor 8, to cause feedback voltage signals Vdcfb whose value is lower than that the resistances 10, 11, 12, and 13 could cause. As a result, the voltage Vdc on the both ends of the smoothing capacitor 8 is adjusted to a higher value than that if there is no optional device connected. If one or more optional devices are additionally connected, it is necessary to prepare a photocoupler and a resistance in which a short-circuit is caused by the photocoupler, for each of the optional devices additionally connected.

When the optional devices and 301 and 302 are connected, the voltage Vdc on the both ends of the smoothing capacitor 8 is adjusted to a predetermined value depending on the combination of the types of the optional devices connected, for example according to the table of FIG. 4.

According to the setting of FIG. 4, when a finisher and an LCT are both connected as optional devices, the voltage Vdc is adjusted to 370V; when a finisher and an ADF are both connected, the voltage Vdc is adjusted to 360V; and when an LCT and an ADF are both connected, the voltage Vdc is adjusted to 350V. When a finisher, an LCT, and an ADF are all connected, the voltage Vdc is adjusted to 390V according to the setting.

The higher the full load current applied to the combination of the optional devices is, the higher value the voltage Vdc will be adjusted to according to the setting. Depending on the combination of the types of the optional devices connected, their matching photocouplers are turned ON and a short-circuit is caused in their matching resistances. And the resistances excluding their matching resistances produce a voltage divider effect at their own and predetermined voltage dividing ratios so that the voltage Vdc will be adjusted to a predetermined value.

FIG. 5 is a flowchart representing the operation to select a predetermined value of the voltage (boosted voltage) Vdc on the both ends of the smoothing capacitor 8, which is performed by the control of the CPU 39.

In Step S01 of FIG. 5, it is judged whether or not there are any optional devices connected. If it is judged that there are no optional devices connected (NO in Step S01), the body controller board 23 turns OFF both the photocouplers 131 and 132 in Step S02. Here, the resistances 10, 11, 12, and 13 exert a voltage divider effect on the boosted voltage Vdc stored on the smoothing capacitor 8, to cause feedback voltage signals Vdcfb. That results in giving a priority to power supplying device efficiency over power factor; while the boosted voltage Vdc on the both ends of the smoothing capacitor 8 is adjusted around to a constant value, 300V for example, the power factor and the power supplying device efficiency are kept to 90% and 85%, for example, respectively. And this leads to reduction of the value of typical electricity consumption (TEC value) and saving on energy consumption.

When there are no optional devices connected, the voltage Vdc on the both ends of the smoothing capacitor 8 may be adjusted to a certain value which can achieve a peak efficiency in power supplying device with the maximum load current expected during the print operation of the body 201 of the image forming apparatus or with a rated input voltage, according to the setting.

Back to the flowchart, if it is judged by the CPU 39 that there are any optional devices connected (YES in Step S01), the type of such an optional device or the combination of the types of such optional devices is identified in Step S03. And in Step S04, the body controller board 23 turns ON the photocoupler 131 or 132 to cause a short-circuit in the resistance 12 or 13, depending on the type of the optional device or the combination of the types of the optional device. That results in changing the voltage division ratio of the resistance 12 or 13, and the boosted voltage Vdc on the both ends of the smoothing capacitor 8 is adjusted around to a predetermined value.

More specifically, when there are any optional devices connected, it is preferred to adjust the voltage Vdc on the both ends of the smoothing capacitor 8 to a certain value which can keep the input current from the alternating-current source 1 within the range of the rated ampacity of a power supplying device code connected to the alternating-current source 1, in order to prevent a trouble due to a fault current exceeding the rated ampacity.

The modes of implementing the present invention have been described in the foregoing specification, which does not mean that the present invention shall be construed as limited to the particular forms set forth herein. The examples described herein may be varied in many ways.

For example, when there is an optional device connected while the body 201 of the image forming apparatus including the CPU 39 of the body controller board 23 is in standby mode (sleep mode) for energy saving, the voltage Vdc on the both ends of the smoothing capacitor 8 may be adjusted to the same value as when there is no optional device connected, because the optional device is not used during the energy-saving period, actually.

The present invention having been described above may be applied to the following modes.

[1] A power supplying device comprising:
a rectifier circuit which rectifies an alternating current inputted from an alternating-current source;
a booster circuit which boosts and smooths the direct-current voltage caused by the rectifier circuit;
a judgment portion which judges whether or not there is an optional device connected to the body of an image forming apparatus;
an identification portion which identifies the type of the optional device connected thereto; and
   a controller which, if there is an optional device connected thereto according to the judgment portion, adjusts the boosted voltage obtained by the booster circuit to a higher value than that if there is no optional device connected thereto, which depends on the type of the optional device identified by the identification portion.

[2] A power supplying device comprising:
a rectifier circuit which rectifies an alternating current inputted from an alternating-current source;
a booster circuit which boosts and smooths the direct-current voltage caused by the rectifier circuit;
a judgment portion which judges whether or not there are a plurality of optional devices connected to the body of an image forming apparatus;
an identification portion which identifies the combination of the optional devices connected thereto; and
a controller which, if there are a plurality of optional devices connected thereto according to the judgment portion, adjusts the boosted voltage obtained by the booster circuit to a higher value than that if there are no optional devices connected thereto, which depends on the combination of the optional devices identified by the identification portion.

[3] The power supplying device as recited in the aforementioned item [1] or [2], wherein the higher the full load current applied to the optional devices connected to the body of the image forming apparatus is, the higher value the boosted voltage obtained by the booster circuit is adjusted to.

[4] The power supplying device as recited in any of the aforementioned items [1] to [3], wherein if there are no optional devices connected to the body of the image forming apparatus, the boosted voltage obtained by the booster circuit is adjusted to a certain value which can achieve a peak efficiency in power supplying device with the maximum load current.

[5] The power supplying device as recited in any of the aforementioned items [1] to [3], wherein if there are no optional devices connected to the body of the image forming apparatus, the boosted voltage obtained by the booster circuit is adjusted to a certain value which can achieve a peak efficiency in power supplying device with a rated input voltage.

[6] The power supplying device as recited in any of the aforementioned items [1] to [5], wherein if there are a plurality of optional devices connected to the body of the image forming apparatus, the boosted voltage obtained by the booster circuit is adjusted to a certain value which can keep the input current from the alternating-current source within the range of the rated ampacity of a power supplying device code connected to the alternating-current source.

[7] The power supplying device as recited in any of the aforementioned items [1] to [6], wherein the judgment portion judges that there are a plurality of optional devices connected to the body of the image forming apparatus, by detecting that the optional devices are connected to their particular connectors installed on the body of the image forming apparatus.

[8] The power supplying device as recited in any of the aforementioned items [1] to [7], wherein if there are a plurality of optional devices connected to the body of the image forming apparatus while the body of the image forming apparatus is in standby mode for energy saving, the boosted voltage obtained by the booster circuit is kept at the same level as that if there are no optional devices connected thereto.

[9] The power supplying device as recited in any of the aforementioned items [1] to [8], the body of the image forming apparatus is connected to by the optional devices after being shipped from factory.

[10] An image forming apparatus comprising: a connector being configured to connect an optional device to the body of the image forming apparatus; and a power supplying device as recited in any of the aforementioned items [1] to [9].

According to the invention in the aforementioned item [1], when there is an optional device connected to the body of the image forming apparatus, the power supplying device is allowed to adjust the boosted voltage obtained by the booster circuit to a higher value than that if there is no optional device connected thereto, which depends on the type of the optional device connected thereto. This can achieve the best power supplying device efficiency and power factor for the type of the optional device connected to the body of the image forming apparatus. More specifically, when there is no optional device connected to the body of the image forming apparatus, the power supplying device is allowed to give a priority to power supplying device efficiency over power factor, i.e. reduce the value of typical electricity consumption (TEC value) for energy saving; and when there is an optional device connected to the body of the image forming apparatus, the power supplying device is allowed to control the input current from the alternating-current source to give a priority to power factor over power supplying device efficiency, i.e. adjust the boosted voltage to a higher value than that when there is no optional device connected thereto, which depends on the type of the optional device connected thereto.

According to the invention in the aforementioned item [2], when there are a plurality of optional devices connected to the body of the image forming apparatus, the power supplying device is allowed to adjust the boosted voltage obtained by the booster circuit to a higher value than that if there are no optional devices connected thereto, which depends on the combination of the optional devices connected thereto. More specifically, when there are no optional devices connected to the body of the image forming apparatus, the power supplying device is allowed to give a priority to power supplying device efficiency over power factor, i.e. reduce the value of typical electricity consumption (TEC value) for energy saving; and when there are a plurality of optional devices connected to the body of the image forming apparatus, the power supplying device is allowed to restrict the input current from the alternating-current source to give a priority to power factor over power supplying device efficiency, i.e. adjust the boosted voltage to a higher value than that when there are no optional devices connected thereto, which depends on the combination of the optional devices connected thereto.

According to the invention in the aforementioned item [3], the higher the full load current applied to the optional devices connected to the body of the image forming apparatus is, the higher value the boosted voltage obtained by the booster circuit is adjusted to.

According to the invention in the aforementioned item [4], the power supplying device is allowed to ensure a high efficiency in power supplying device.

According to the invention in the aforementioned item [5], the power supplying device is allowed to ensure a high efficiency in power supplying device.

According to the invention in the aforementioned item [6], the power supplying device is allowed to prevent a trouble from occurring to a power supplying device code because of a fault current exceeding the rated ampacity.

According to the invention in the aforementioned item [7], the power supplying device is allowed to detect that there are optional devices connected to the body of the image forming apparatus, with a comparatively simple configuration.

According to the invention in the aforementioned item [8], when there are optional devices connected to the body of the image forming apparatus while the body of the image forming apparatus is in standby mode for energy saving, the power supplying device is allowed to keep the power supplying device efficiency at the same level as that if there are no optional devices connected thereto.

According to the invention in the aforementioned item [9], even if the body of the image forming apparatus is being connected to by an optional device after being shipped from factory, the power supplying device is also allowed to control the input power in a perfect manner.

According to the invention in the aforementioned item [10], the image forming apparatus is allowed to adjust the input power to the most preferred value for the type of an optional device or the combination of optional devices.

While the present invention may be embodied in many different forms, a number of illustrative embodiments are described herein with the understanding that the present disclosure is to be considered as providing examples of the principles of the invention and such examples are not intended to limit the invention to preferred embodiments described herein and/or illustrated herein.

While illustrative embodiments of the invention have been described herein, the present invention is not limited to the various preferred embodiments described herein, but includes any and all embodiments having equivalent elements, modifications, omissions, combinations (e.g. of aspects across various embodiments), adaptations and/or alterations as would be appreciated by those in the art based on the present disclosure. The limitations in the claims are to be interpreted broadly based on the language employed in the claims and not limited to examples described in the present specification or during the prosecution of the application, which examples are to be construed as non-exclusive. For example, in the present disclosure, the term “preferably” is non-exclusive and means “preferably, but not limited to”. In this disclosure and during the prosecution of this application, means-plus-function or step-plus-function limitations will only be employed where for a specific claim limitation all of the following conditions are present In that limitation: a) “means for” or “step for” is expressly recited; b) a corresponding function is expressly recited; and c) structure, material or acts that support that structure are not recited. In this disclosure and during the prosecution of this application, the terminology “present invention” or “invention” may be used as a reference to one or more aspect within the present disclosure. The language present invention or invention should not be improperly interpreted as an identification of criticality, should not be improperly interpreted as applying across all aspects or embodiments (i.e., it should be understood that the present invention has a number of aspects and embodiments), and should not be improperly interpreted as limiting the scope of the application or claims. In this disclosure and during the prosecution of this application, the terminology “embodiment” can be used to describe any aspect, feature, process or step, any combination thereof, and/or any portion thereof, etc. In some examples, various embodiments may include overlapping features. In this disclosure and during the prosecution of this case, the following abbreviated terminology may be employed: “e.g.” which means “for example”, and “NB” which means “note well”.

What is claimed is:

1. A power supplying device providing power to the body of an image forming apparatus and an optional device connected to the body of the same, the power supplying device comprising:
a rectifier circuit which rectifies an alternating current inputted from an alternating-current source;
a booster circuit which boosts and smooths the direct-current voltage caused by the rectifier circuit;
a judgment portion which judges whether or not there is an optional device connected to the body of the image forming apparatus;
an identification portion which identifies the type of the optional device connected thereto; and
a controller which, if there is an optional device connected thereto according to the judgment portion, adjusts the boosted voltage obtained by the booster circuit to a higher value than that if there is no optional device connected thereto, which depends on the type of the optional device identified by the identification portion.

2. The power supplying device as recited in claim 1, wherein the higher the full load current applied to the optional device connected to the body of the image forming apparatus is, the higher value the boosted voltage obtained by the booster circuit is adjusted to.

3. The power supplying device as recited in claim 1, wherein if there is no optional device connected to the body of the image forming apparatus, the boosted voltage obtained by the booster circuit is adjusted to a certain value which can achieve a peak efficiency in power supplying device with the maximum load current.

4. The power supplying device as recited in claim 1, wherein if there is no optional device connected to the body of the image forming apparatus, the boosted voltage obtained by the booster circuit is adjusted to a certain value which can achieve a peak efficiency in power supplying device with a rated input voltage.

5. The power supplying device as recited in claim 1, wherein if there is an optional device connected to the body of the image forming apparatus, the boosted voltage obtained by the booster circuit is adjusted to a certain value which can keep the input current from the alternating-current source within the range of the rated ampacity of a power supplying device code connected to the alternating-current source.

6. The power supplying device as recited in claim 1, wherein the judgment portion judges that there is an optional device connected to the body of the image forming apparatus, by detecting that the optional device is connected to its particular connector installed on the body of the image forming apparatus.

7. The power supplying device as recited in claim 1, wherein if there is an optional device connected to the body of the image forming apparatus while the body of the image forming apparatus is in standby mode for energy saving, the boosted voltage obtained by the booster circuit is kept at the same level as that if there is no optional device connected thereto.

8. The power supplying device as recited in claim 1, wherein the body of the image forming apparatus is connected to by the optional device after being shipped from factory.

9. An image forming apparatus comprising:
the power supplying device according to claim 1;
the body of the image forming apparatus; and
a connector being configured to connect an optional device to the body of the image forming apparatus.

10. A power supplying device achieving the control of another power supplying device providing power to the body of an image forming apparatus and an optional device connected to the body of the same, the power supplying device comprising:
a rectifier circuit which rectifies an alternating current inputted from an alternating-current source;
a booster circuit which boosts and smooths the direct-current voltage caused by the rectifier circuit;
a judgment portion which judges whether or not there are a plurality of optional devices connected to the body of the image forming apparatus;
an identification portion which identifies the combination of the optional devices connected thereto; and
a controller which, if there are a plurality of optional devices connected thereto according to the judgment portion, adjusts the boosted voltage obtained by the booster circuit to a higher value than that if there are no optional devices connected thereto, which depends on the combination of the optional devices identified by the identification portion.

11. The power supplying device as recited in claim 10, wherein the higher the full load current applied to the optional devices connected to the body of the image forming apparatus is, the higher value the boosted voltage obtained by the booster circuit is adjusted to.

12. The power supplying device as recited in claim 10, wherein if there are no optional devices connected to the body of the image forming apparatus, the boosted voltage obtained by the booster circuit is adjusted to a certain value which can achieve a peak efficiency in power supplying device with the maximum load current.

13. The power supplying device as recited in claim 10, wherein if there are no optional devices connected to the body of the image forming apparatus, the boosted voltage obtained by the booster circuit is adjusted to a certain value which can achieve a peak efficiency in power supplying device with a rated input voltage.

14. The power supplying device as recited in claim 10, wherein if there are a plurality of optional devices connected to the body of the image forming apparatus, the boosted voltage obtained by the booster circuit is adjusted to a certain value which can keep the input current from the alternating-current source within the range of the rated ampacity of a power supplying device code connected to the alternating-current source.

15. The power supplying device as recited in claim 10, wherein the judgment portion judges that there are a plurality of optional devices connected to the body of the image forming apparatus, by detecting that the optional devices are connected to their particular connectors installed on the body of the image forming apparatus.

16. The power supplying device as recited in claim 10, wherein if there are a plurality of optional devices connected to the body of the image forming apparatus while the body of the image forming apparatus is in standby mode for energy saving, the boosted voltage obtained by the booster circuit is kept at the same level as that if there are no optional devices connected thereto.

17. The power supplying device as recited in claim 10, the body of the image forming apparatus is connected to by the optional devices after being shipped from factory.

18. An image forming apparatus comprising:
the power supplying device according to claim 10;
the body of the image forming apparatus; and
a connector being configured to connect an optional device to the body of the image forming apparatus.
